(19) United States
(12) Patent Application Publication
(10) Pub. No.: US 2026/0126757 A1
(43) Pub. Date: May 7, 2026

(54) IMAGE FORMING APPARATUS

(71) Applicant: Konica Minolta, Inc., Tokyo (JP)

(72) Inventor: Hideyuki UMENO, Kanagawa (JP)

(21) Appl. No.: 19/348,920

(22) Filed: Oct. 3, 2025

(30) Foreign Application Priority Data
Nov. 1, 2024 (JP) 2024-192916

(51) Int. Cl. G03G 21/20; G03G 15/20; G03G 21/16

(52) U.S. Cl. CPC G03G 21/206; G03G 15/2017; G03G 15/2064; G03G 21/1633; G03G 2215/2032

(57) ABSTRACT

Provided is an image forming apparatus that forms an image on a recording medium and includes: a fixer that includes a housing, in which an opening is formed, and fixes the image formed on the recording medium; a wind blower that blows wind in the housing; and a guide that guides the wind blowing out from the opening such that the wind is diffused in the image forming apparatus.

### CROSS REFERENCE TO RELATED APPLICATIONS

The entire disclosure of Japanese patent Application No.2024-192916, filed on November 1, 2024, is incorporated herein by reference in its entirety.

### BACKGROUND

### 1 . Technological Field

The present invention relates to an image forming apparatus.

### 2. Description of the Related Art

An image forming apparatus is provided with a fixing apparatus that heat-fixes an image (toner image) onto a recording medium. It is known that such a fixing apparatus is provided with a wind blowing apparatus. For example, Japanese Patent Publication Laid-Open No. 2006-17922 discloses a configuration in which an exhaust route for discharging heat, which is emitted from a heat generating source, to the outside of an apparatus body is provided.

### SUMMARY

Incidentally, the housing of the fixing apparatus (fixer) may include a gap (opening), for example, at an openable and closable cover portion for jam processing, at a joint portion of a plurality of sheet metal members, or the like. In this case, wind from a wind blowing apparatus (wind blower) may blow out from the opening, and consequently there is a risk that the wind blowing out from the opening will be diffused over the entire apparatus.

An object of the present invention is to provide an image forming apparatus capable of suppressing diffusion of wind blowing out from an opening of a fixer over an entire apparatus.

In order to achieve at least one of the above-described objects, an image forming apparatus reflecting one aspect of the present invention is an image forming apparatus that forms an image on a recording medium. The image forming apparatus includes:

a fixer that includes a housing, in which an opening is formed, and fixes an image formed on the recording medium;

a wind blower that blows wind in the housing; and

a guide that guides the wind blowing out from the opening such that the wind is not diffused in the image forming apparatus.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating an overall configuration of an image forming apparatus according to an embodiment of the present invention;

FIG. 2 is a diagram illustrating a main part of a control system of the image forming apparatus;

FIG. 3 is a diagram illustrating an example of a configuration of a wind blower;

FIG. 4 is a diagram illustrating a state in which an opener of a housing is opened;

FIG. 5 is a diagram illustrating an example of a configuration of a guide;

FIG. 6 is a diagram illustrating an example of a configuration in which the position of an opening is different;

FIG. 7 is a diagram illustrating an example of the guide according to a variation; and

FIG. 8 is a diagram illustrating an example of the guide according to a variation.

### DETAILED DESCRIPTION OF EMBODIMENTS

Hereinafter, one or more embodiments of the present invention will be described with reference to the drawings. However, the scope of the invention is not limited to the disclosed embodiments.

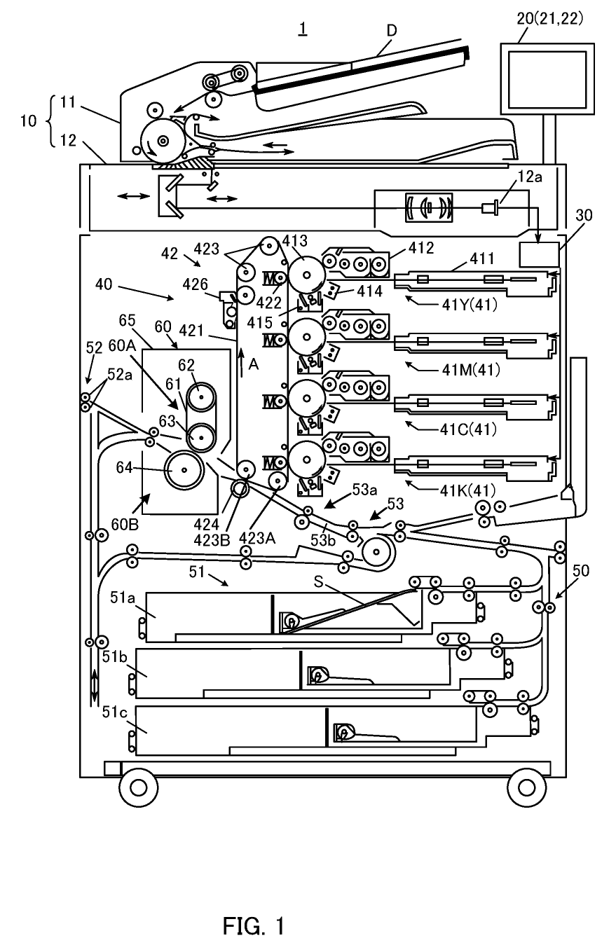

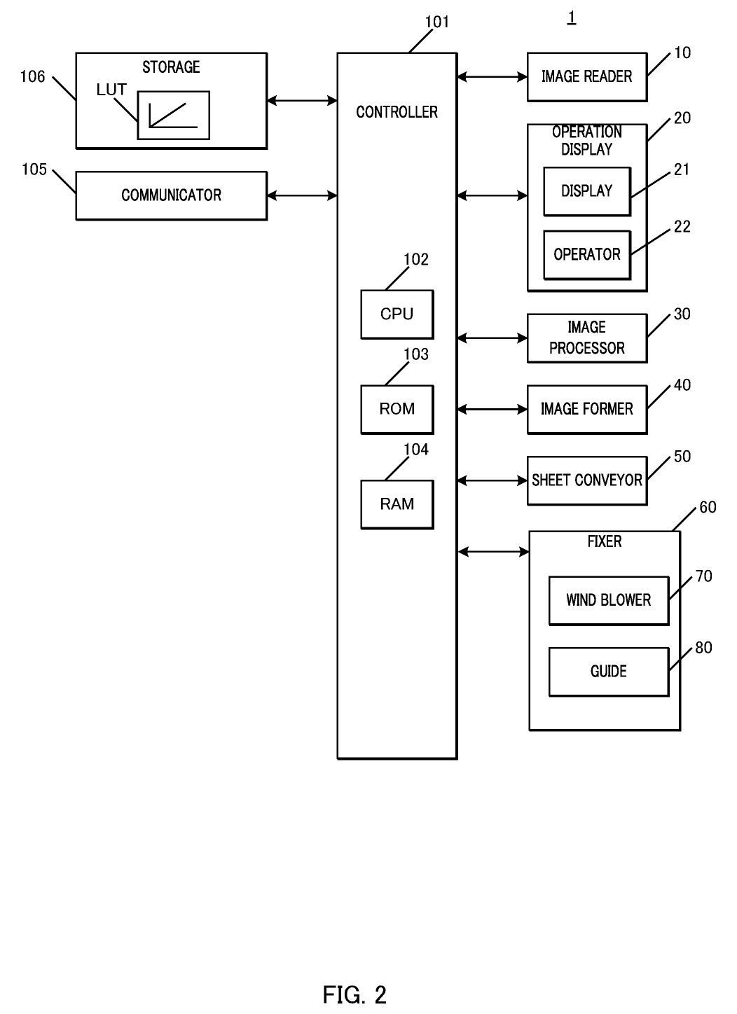

Hereinafter, an embodiment of the present invention will be described in detail with reference to the accompanying drawings. FIG. 1 is a diagram schematically illustrating an overall configuration of an image forming apparatus 1 according to an embodiment of the present invention. FIG. 2 is a diagram illustrating a main part of a control system of the image forming apparatus 1.

As illustrated in FIG. 1, the image forming apparatus 1 is a color image forming apparatus of an intermediate transfer method using an electrophotographic process. That is, the image forming apparatus 1 primary-transfers toner images of colors of yellow (Y), magenta (M), cyan (C), and black (K) formed on photosensitive drums 413 onto an intermediate transfer belt 421, superimposes the toner images of the four colors on one another on the intermediate transfer belt 421, and then secondary-transfers the resultant image onto a sheet S fed out from sheet feed tray units 51a to 51c to form an image.

Further, the image forming apparatus 1 adopts a tandem-system in which the photosensitive drums 413 corresponding to the four colors of Y, M, C, and K are arranged in series in the travel direction of the intermediate transfer belt 421, and the toner images of the respective colors are sequentially transferred onto the intermediate transfer belt 421 by a single procedure.

As illustrated in FIG. 2, the image forming apparatus 1 includes an image reader 10, an operation display 20, an image processor 30, an image former 40, a sheet conveyor 50, a fixer 60, and a controller 101.

The controller 101 includes a central processing unit (CPU) 102, a read only memory (ROM) 103, a random access memory (RAM) 104, and the like. The CPU 102 reads a program corresponding to the processing content from the ROM 103, develops the program in the RAM 104, and performs centralized control of the operation of each block and the like of the image forming apparatus 1 in conjunction with the developed program. At this time, various types of data stored in a storage 106 are referred to. The storage 106 is constituted by, for example, a non-volatile semiconductor memory (so-called flash memory) and/or a hard disk drive.

The controller 101 transmits/receives various types of data to/from an external apparatus (e.g., a computer) connected to a network such as a local area network (LAN) or a wide area network (WAN) via a communicator 105. For example, the controller 101 receives image data (input image data) transmitted from the external apparatus and causes an image to be formed on the sheet S based on the image data. The communicator 105 is constituted by a communication control card such as a LAN card.

As illustrated in FIG. 1, the image reader 10 includes an automatic document feeding apparatus 11 called an auto document feeder (ADF), a document image scanning apparatus 12 (scanner), and the like.

The automatic document feeding apparatus 11 conveys a document D, which has been placed on a document tray, by a conveyance mechanism and feeds out the document D to the document image scanning apparatus 12. The automatic document feeding apparatus 11 makes it possible to continuously and collectively read images of a large number of documents D (including both surfaces) placed on the document tray.

The document image scanning apparatus 12 optically scans a document conveyed from the automatic document feeding apparatus 11 onto a contact glass or a document placed on the contact glass, forms an image of reflected light from the document on a light receiving surface of a charge-coupled device (CCD) sensor 12a, and reads a document image. The image reader 10 generates input image data based on a reading result by the document image scanning apparatus 12. The input image data undergoes predetermined image processing at the image processor 30.

As illustrated in FIG. 2, the operation display 20 is constituted by, for example, a liquid crystal display (LCD) with a touch screen, and functions as a display 21 and an operator 22. The display 21 displays various operation screens, the state of the image, the operation status of each function, and the like according to a display control signal inputted from the controller 101. The operator 22 includes various operation keys such as a numeric keypad, and a start key, receives various input operations from a user, and outputs an operation signal to the controller 101.

The image processor 30 includes a circuit or the like that performs digital image processing corresponding to initial settings or user settings. For example, the image processor 30 performs gradation correction based on gradation correction data (gradation correction table) under the control of the controller 101. The image processor 30 performs, in addition to the gradation correction, various types of correction processing such as color correction and shading correction, compression processing, and the like. The image former 40 is controlled based on the image data on which the above-described pieces of processing have been performed. Details of the image processor 30 will be described later.

As illustrated in FIG. 1, the image former 40 forms an image on the sheet S based on the settings of a print job. The image former 40 includes image forming units 41Y, 41M, 41C, and 41K for forming images with color toners of Y, M, C, and K components based on the input image data, an intermediate transfer unit 42, and the like.

The image forming units 41Y, 41M, 41C, and 41K for the Y, M, C, and K components have a similar configuration. For convenience of illustration and description, common constituent elements are denoted by the same reference signs, and in a case where the common constituent elements are distinguished from each other, Y, M, C, or K is added to the reference signs. In FIG. 1, reference signs are assigned to only the constituent elements of the image forming unit 41Y for the Y component and the reference signs of the constituent elements of the other image forming units 41M, 41C, 41K are omitted.

The image forming unit 41 includes an exposure apparatus 411, a developing apparatus 412, a photosensitive drum 413, a charging apparatus 414, a drum cleaning apparatus 415, and the like.

The photosensitive drum 413 is made of, for example, an organic photoreceptor in which a photosensitive layer made of a resin containing an organic photoconductor is formed on the outer periphery surface of a drum-shaped metal base.

The controller 101 controls a drive current supplied to a drive motor (not illustrated) that rotates the photosensitive drum 413 to rotate the photosensitive drum 413 at a constant peripheral speed.

The charging apparatus 414 is, for example, a charging charger, and uniformly charges the surface of the photosensitive drum 413 having photoconductivity to a negative polarity by generating corona discharge.

The exposure apparatus 411 is constituted by, for example, a semiconductor laser, and emits laser light corresponding to an image of each color component to the photosensitive drum 413. As a result, in the surface of the photosensitive drum 413, due to a potential difference from the background region, an electrostatic latent image of each color component is formed on the image region to which the laser light is emitted.

The developing apparatus 412 is a developing apparatus of a two-component reverse rotation type, and forms a toner image by causing a developer of each color component to adhere to the surface of the photosensitive drum 413 to visualize an electrostatic latent image.

For example, DC developing bias having the same polarity as a charge polarity of the charging apparatus 414 or developing bias, in which DC voltage having the same polarity as the charge polarity of the charging apparatus 414 is superimposed on AC voltage, is applied to the developing apparatus 412. As a result, inversion development is performed in which a toner is caused to adhere to an electrostatic latent image formed by the exposure apparatus 411.

The drum cleaning apparatus 415 is caused to abut on the surface of the photosensitive drum 413, includes a plate-shaped cleaning blade made of an elastic body or the like, and removes a toner not transferred onto the intermediate transfer belt 421 and remaining on the surface of the photosensitive drum 413.

The intermediate transfer unit 42 includes the intermediate transfer belt 421, primary transfer rollers 422, a plurality of support rollers 423, a secondary transfer roller 424, a belt cleaning apparatus 426, and the like.

The intermediate transfer belt 421 is constituted by an endless-shaped belt and is stretched in a loop shape over the plurality of support rollers 423. At least one of the plurality of support rollers 423 is constituted by a drive roller, and the other support roller(s) 423 is/are constituted by a driven roller(s). For example, a roller 423A disposed on the downstream side of the primary transfer roller 422 for the K component in the belt travel direction is preferably a drive roller. Thus, the travel speed of the belt at a primary transfer section is easily kept constant. The rotation of the drive roller 423A causes the intermediate transfer belt 421 to travel in the direction of an arrow A at a constant speed.

The intermediate transfer belt 421 is a belt having conductivity and elasticity, and includes a high-resistance layer on the surface thereof. The intermediate transfer belt 421 is rotationally driven by a control signal from the controller 101.

The primary transfer roller 422 is disposed on the side of the inner periphery surface of the intermediate transfer belt 421 with the primary transfer roller 422 facing the photosensitive drum 413 of each color component. The primary transfer roller 422 is brought into pressure contact with the photosensitive drum 413 with the intermediate transfer belt 421 held therebetween, thereby forming a primary transfer nip for transferring a toner image from the photosensitive drum 413 onto the intermediate transfer belt 421.

The secondary transfer roller 424 is disposed on the side of the outer peripheral surface of the intermediate transfer belt 421 with the secondary transfer roller 424 facing a backup roller 423B disposed on the downstream side of the drive roller 423A in the belt travel direction. The secondary transfer roller 424 is brought into pressure contact with the backup roller 423B with the intermediate transfer belt 421 held therebetween, thereby forming a secondary transfer nip for transferring a toner image from the intermediate transfer belt 421 onto the sheet S.

When the intermediate transfer belt 421 passes through the primary transfer nips, the toner images on the photosensitive drums 413 are sequentially superimposed and primary-transferred onto the intermediate transfer belt 421. Specifically, the toner image is electrostatically transferred onto the intermediate transfer belt 421 by applying primary transfer bias to the primary transfer roller 422, and applying electric charge having an opposite polarity of the toner to the side of the back surface of the intermediate transfer belt 421, that is, the side on which the primary transfer roller 422 abuts.

Thereafter, when the sheet S passes through the secondary transfer nip, the toner image on the intermediate transfer belt 421 is secondary-transferred onto the sheet S. Specifically, the toner image is electrostatically transferred onto the sheet S by applying secondary transfer bias to the secondary transfer roller 424, and applying electric charge having an opposite polarity of the toner to the side of the back surface of the sheet S, that is, the side on which the secondary transfer roller 424 abuts. The sheet S onto which the toner image has been transferred is conveyed toward the fixer 60.

The belt cleaning apparatus 426 removes a transfer residual toner remaining on the surface of the intermediate transfer belt 421 after the secondary transfer.

The fixer 60 includes an upper-side fixer 60A, a lower-side fixer 60B, a heating source, and the like. The upper-side fixer 60A includes a fixing surface-side member that is disposed on the side of a fixing surface of the sheet S, that is, the surface on which the toner image has been formed. The lower-side fixer 60B includes a back surface-side supporting member that is disposed on the side of the back surface of the sheet S, that is, the side of the surface opposite to the fixing surface. The back surface-side supporting member is brought into pressure contact with the fixing-surface-side member, so that a fixing nip is formed which holds the sheet S in between and conveys the sheet S.

The fixer 60 heats and pressurizes the conveyed sheet S, onto which the toner image has been secondary-transferred, at the fixing nip, thereby fixing the toner image on the sheet S. The fixer 60 is disposed as a unit in a fixing device.

The upper-side fixer 60A includes a fixing belt 61 having an endless shape, which is the fixing-surface-side member, a heating roller 62, and a fixing roller 63. The fixing belt 61 is stretched by the heating roller 62 and the fixing roller 63.

The lower-side fixer 60B includes a pressure roller 64 that is the back surface-side supporting member. The pressure roller 64 and the fixing belt 61 form a fixing nip that holds the sheet S in between and conveys the sheet S.

A housing 65 that houses each member of the fixer 60 is provided with a wind blower 70. In addition, a guide 80 that guides wind blown by the wind blower 70 and blowing out from the housing 65 is provided around the housing 65. Details of the wind blower 70 and the guide 80 will be described later.

The sheet conveyor 50 includes a sheet feeder 51, a sheet ejector 52, a conveyance route 53, and the like. In the three sheet feed tray units 51a to 51c constituting the sheet feeder 51, sheets S (standard sheets, special sheets) identified based on basis weight, size, and the like are housed for each type set in advance.

The conveyance route 53 includes a plurality of conveyance roller pairs such as a registration roller pair 53a, a normal conveyance path 53b along which the sheet S is passed through the image former 40 and the fixer 60 and is ejected to the outside of the image forming apparatus 1, and the like.

The sheets S housed in the sheet feed tray units 51a to 51c are fed out one by one starting from the uppermost sheet S and are conveyed to the image former 40 by the conveyance route 53. At the image former 40, the toner image on the intermediate transfer belt 421 is collectively secondary-transferred onto one surface of the sheet S, and a fixing process is performed at the fixer 60. The sheet S on which an image has been formed is ejected to the outside of the apparatus by the sheet ejector 52 including sheet ejection rollers 52a.

Next, details of the wind blower 70 and the guide 80 will be described.

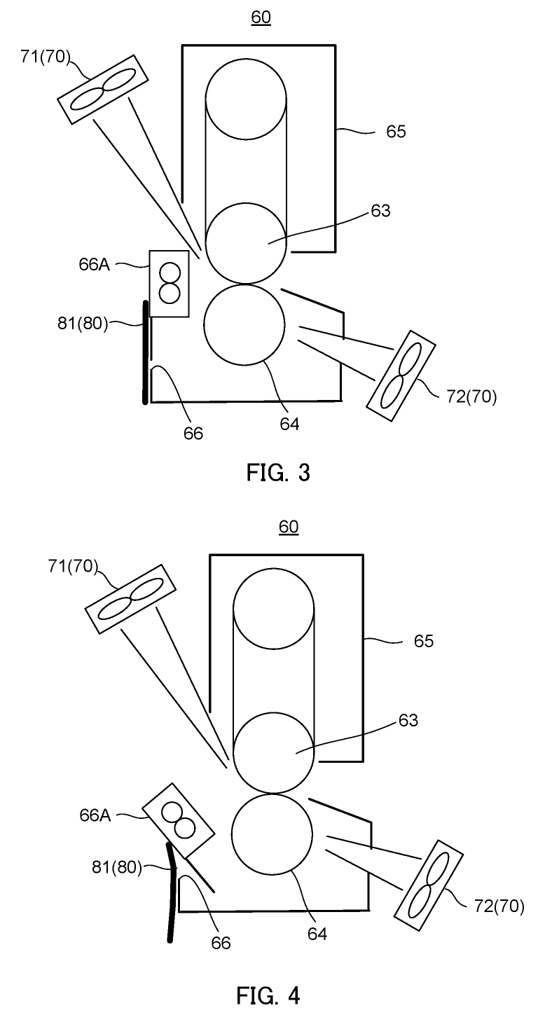

As illustrated in FIG. 3, the wind blower 70 is a wind blowing apparatus that generates wind in the housing 65 of the fixer 60, and includes a first wind blower 71 and a second wind blower 72.

The first wind blower 71 is a wind blowing apparatus for controlling the posture of the recording medium that has passed through the fixing nip in the fixer 60. The first wind blower 71 is provided at a position facing the conveyance surface of the recording medium on the downstream side of the fixing nip in the conveyance direction of the recording medium, and controls the posture of the recording medium by blowing wind toward the recording medium on the conveyance surface.

The second wind blower 72 is a wind blowing apparatus for cooling the fixing members such as the fixing roller 63 and the pressure roller 64. The second wind blower 72 is provided at a position opposite to the first blower 71 with respect to the fixing nip on the upstream side of the fixing nip in the conveyance direction of the recording medium, and cools the fixing members by blowing wind toward the pressure roller 64 and the like.

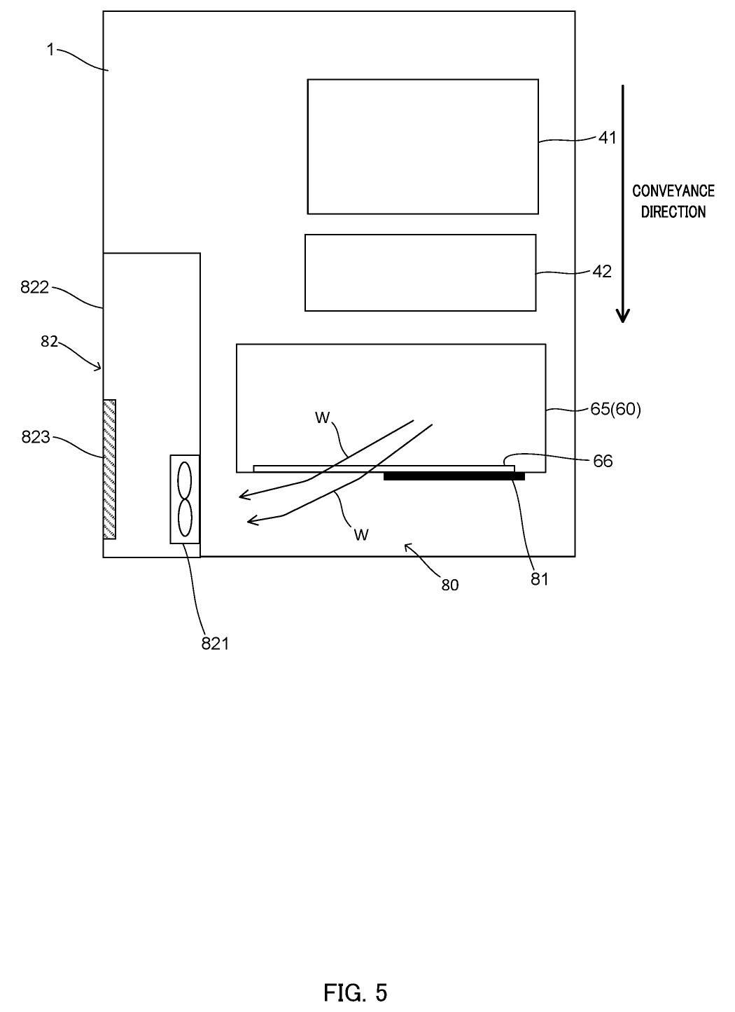

In addition, an opening 66 is formed in the housing 65 of the fixer 60. The opening 66 is formed in a portion of the housing 65 on the downstream side of the fixing nip in the conveyance direction described above. Specifically, this portion is, for example, an opener 66A for jam processing, which is openable and closable (see also FIG. 4), and the opening 66 is a gap between the opener 66A and the housing 65. That is, the opening 66 is provided on a side surface of the housing 65 on the downstream side in the conveyance direction of the recording medium, and extends, for example, in the width direction of the recording medium (see also FIG. 5).

When the opening 66 as such is formed, wind from the wind blower 70 blows out from the opening 66. When wind blows out from the housing 65 through the opening 66, the wind may be diffused in the image forming apparatus 1. Wind blowing out from the housing 65 has a high temperature due to the heat of the fixer 60, and thus, there is a risk that the wind will blow out from the opening 66 and will be diffused in the image forming apparatus 1, and further that the temperature in the image forming apparatus 1 will increase due to the wind.

In addition, since the surface of the fixing roller 63 and the like in the fixer 60 is constituted by a silicon rubber material, ultra fine particles (UFPs) are likely to be generated due to heating, and a large amount of floating UFPs are in the atmosphere in the fixer 60 due to the wind by the wind blower 70. Further, the toner before fixing may float due to the wind by the wind blower 70. For this reason, wind blowing out from the fixer 60 may contain the toner on the recording medium and UFPs. In this case, when wind is diffused in the image forming apparatus 1, each member in the image forming apparatus 1 may be contaminated with the toner or UFPs may adhere to each member.

In the present embodiment, diffusion of wind blowing out from the opening 66 in the image forming apparatus 1 is suppressed by providing the guide 80. That is, the guide 80 guides wind blowing from the opening 66 such that the wind is not diffused in the image forming apparatus 1. As illustrated in FIGS. 3 and 5, the guide 80 includes a shielding member 81 and a discharger 82.

The shielding member 81 is a sheet-shaped member that partially shields the opening 66, and is constituted by an elastically deformable material (for example, polyethylene terephthalate). The shielding member 81 is disposed so as to shield a portion including an end of the opening 66 opposite to the discharger 82, which will be described later, with respect to the housing 65 and so as not to shield a portion including an end of the opening 66 on a side of the discharger 82 with respect to the housing 65. That is, the shielding member 81 is disposed so as to shield the side opposite to the side, on which the discharger 82 is disposed, with respect to the center of the opening 66 in the extending direction, and so as not to shield the side on which the discharger 82 is disposed.

Thus, wind W by the wind blower 70 blows out from the portion of the opening 66, which is not shielded by the shielding member 81.

As illustrated in FIG. 5, the discharger 82 is an apparatus that discharges air in the image forming apparatus 1, and is provided on a lateral side of the housing 65 in the image forming apparatus 1. The lateral side of the housing 65 in the image forming apparatus 1 is, for example, a sidewall portion on one side of a pair of sidewalls of the image forming apparatus 1 in the extending direction of the opening 66.

The discharger 82 includes a sucker 821, a box 822, and a collector 823.

The sucker 821 is an exhaust fan that sucks air in the image forming apparatus 1, and is configured to suck wind blowing out from the opening 66 of the housing 65 by being provided on the lateral side of the housing 65.

The box 822 is a box for retaining air (wind) sucked by the sucker 821, and is provided in a portion of the image forming apparatus 1 where the sucker 821 is provided.

The collector 823 is, for example, an ozone filter (UFP filter) constituted by activated carbon having a honeycomb structure and collects UFPs contained in the air passing through the collector 823. The collector 823 is provided at a wall of the box 822 opposite to the sucker 821, and is configured to be detachable from the box 822.

In the discharger 82, the air (wind W) sucked by the sucker 821 is, while being diffused in the box 822, discharged to the outside of the image forming apparatus 1 via the collector 823. At this time, UFPs contained in the air are collected by the collector 823.

In the guide 80, the shielding member 81 shields the opening 66, thereby guiding the wind blowing from the opening 66 to the outside of the image forming apparatus via the discharger 82. Specifically, since the shielding member 81 shields the portion of the opening 66 on the side opposite to the discharger 82, the wind W blows out only from the portion of the opening 66 on the side close to the discharger 82. Since the region from which the wind W blows out is relatively close to the sucker 821, the wind W in the region is more likely to be sucked by the suction force of the sucker 821. As a result, the wind W that has blown out from the opening 66 can be efficiently guided to the outside of the image forming apparatus 1 via the discharger 82.

In addition, since the portion of the opening 66 on the side far from the discharger 82 is shielded by the shielding member 81, the wind does not blow out from the region near the portion where the shielding member 81 is disposed. The region is separated from the sucker 821 and is less likely to be sucked by the sucker 821, and thus, in a case where the wind W blows out from the region, the wind W is likely to be diffused in the image forming apparatus 1.

In the present embodiment, the wind W does not blow out from the region due to the shielding member 81, and the wind W blows out from a region relatively close to the discharger 82, so that the wind W can be more easily discharged by the discharger 82. That is, in the present embodiment, it is possible to efficiently guide the wind W to the outside of the image forming apparatus 1, and further it is possible to suppress the wind W that has blown out from the opening 66 of the fixer 60 from being diffused in the apparatus in its entirety.

In addition, since the shielding member 81 is formed in a sheet shape, for example, it is possible to suppress blowing out of the wind W from the housing 65 only by attaching the shielding member 81 to a portion of the housing 65 of the fixer 60 where there is a gap (the opening 66). As a result, diffusion of the wind W in the image forming apparatus 1 can be suppressed.

For this reason, it is possible to suppress a temperature increase in the image forming apparatus 1, contamination of each member with toner, and adhesion of UFPs to each member, which are caused by diffusion of the wind W from the fixer 60 in the image forming apparatus 1.

In addition, since the shielding member 81 is constituted by an elastically deformable material, for example, even when the portion to which the shielding member 81 is attached moves, the shielding member 81 is deformed following the portion (see FIG. 4). For example, in a case where the shielding member 81 is attached to the gap (the opening 66) between the housing 65 and the opener 66A capable of opening the housing 65 for jam processing or the like, the shielding member 81 is deformed as the opener 66A opens and closes.

Thus, it is possible to suppress inhibition of the opening and closing operation of the opener 66A by the shielding member 81 when the opener 66A is opened. That is, the shielding member 81 is capable of shielding the wind blowing from the opening 66 without inhibiting the operation of the attachment portion of the housing 65.

Further, since the wind blowing out from the opening 66 can be guided to the discharger 82 only by providing the shielding member 81, for example, the wind can be guided without using a complicated member for forming a wind path. That is, in the present embodiment, the configuration can be simplified.

In addition, since the discharger 82 is configured to include the box 822 and the collector 823, it is possible to cause the collector 823 to collect UFPs and discharge the UFPs to the outside of the apparatus after the sucked air (wind) is retained in the box 822 to some extent. As a result, it is possible to reduce the wind speed of the air passing through the collector 823 by causing the air to be retained in the box 822.

In addition, since the collector 823 is detachable from the box 822, it is possible to configure such that the collector 823 is easily replaceable. As a result, since the collector 823 can be easily replaced when the collection amount of the collector 823 increases, it is possible to suppress a decrease in the collection amount of the collector 823.

Note that, in the above-described embodiment, the shielding member 81 partially shields the opening 66, but the present invention is not limited to this, and for example, the shielding member 81 may shield the opening entirely. In this case, the guide 80 guides the wind in the housing 65 such that the wind is retained inside the housing 65.

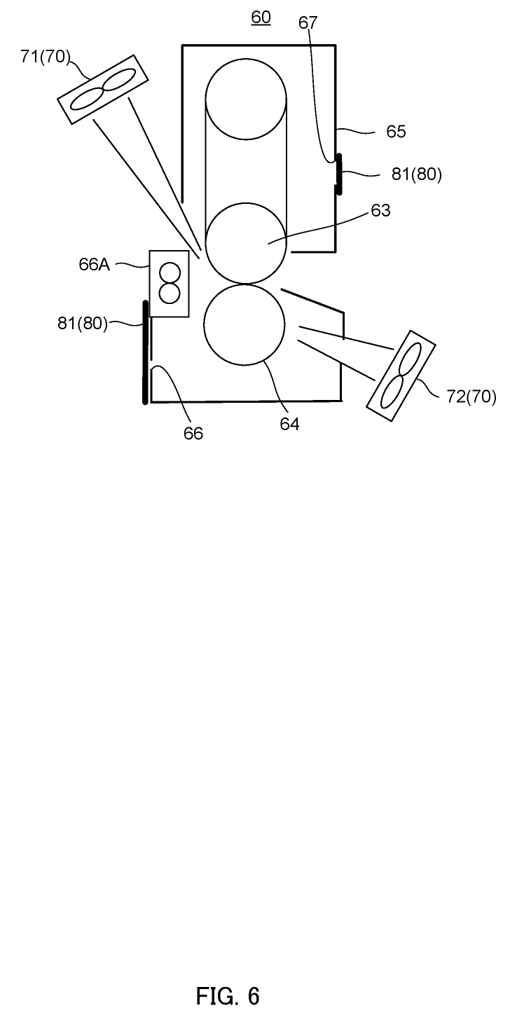

The opening in this case may be formed on the side surface of the housing 65 on the downstream side in the conveyance direction as in the above embodiment, or may be formed on the side surface of the housing 65 on the upstream side in the conveyance direction as illustrated in FIG. 6.

For example, on the side surface of the housing 65 on the upstream side, an opening 67 like a gap, such as a joint between a plurality of sheet metal members, may be formed. On the upstream side of the housing 65, the intermediate transfer unit 42 and the image forming unit 41 are disposed. For this reason, in a case where wind blows out from the opening 67, there is a possibility that the temperature of the intermediate transfer unit 42 and the like will increase.

Accordingly, when the shielding member 81 is provided so as to shield the opening 67 entirely, it is possible to suppress blowing out of wind from the opening 67 and further to suppress a temperature increase in the intermediate transfer unit 42 and the like.

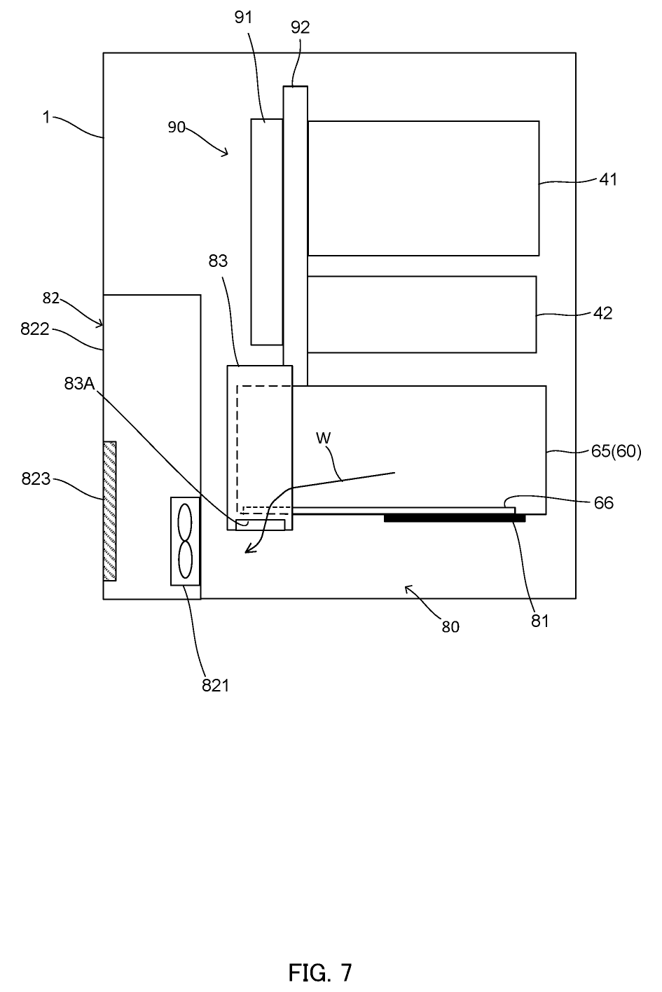

In addition, as illustrated in FIG. 7, the fixer 60 may be disposed adjacent to a driving unit 90 that drives each unit of the image forming apparatus 1. The driving unit 90 includes a drive gear 91 for the image forming unit 41 and the intermediate transfer unit 42, and a panel 92 on which the drive gear 91 is disposed.

The drive gear 91 is disposed on the side of the panel 92 opposite to the image forming unit 41 and the intermediate transfer unit 42, and is disposed on the same side as the discharger 82 in the width direction of the image forming apparatus 1 (the extending direction of the opening 66).

The guide 80 may include a cover 83 that covers a portion of the housing 65 of the fixer 60 on the side on which the shielding member 81 is not disposed in the width direction, that is, the side on which the opening 66 is not shielded.

The cover 83 includes a vent 83A that opens on the side opposite to the driving unit 90 with respect to the housing 65.

That is, since the vent 83A face the side opposite to the driving unit 90, the wind W blowing out from the housing 65 toward the side opposite to the driving unit 90 comes out from the vent 83A and is discharged to the discharger 82. In other words, the vent 83A is formed so as to guide the wind W from the housing 65 toward the discharger 82.

By configuring in the above-described manner, the wind W blowing out from the housing 65 can be prevented from heading toward the side of the driving unit 90, and thus, it is possible to suppress contamination of the drive gear 91 with toner included in the wind W.

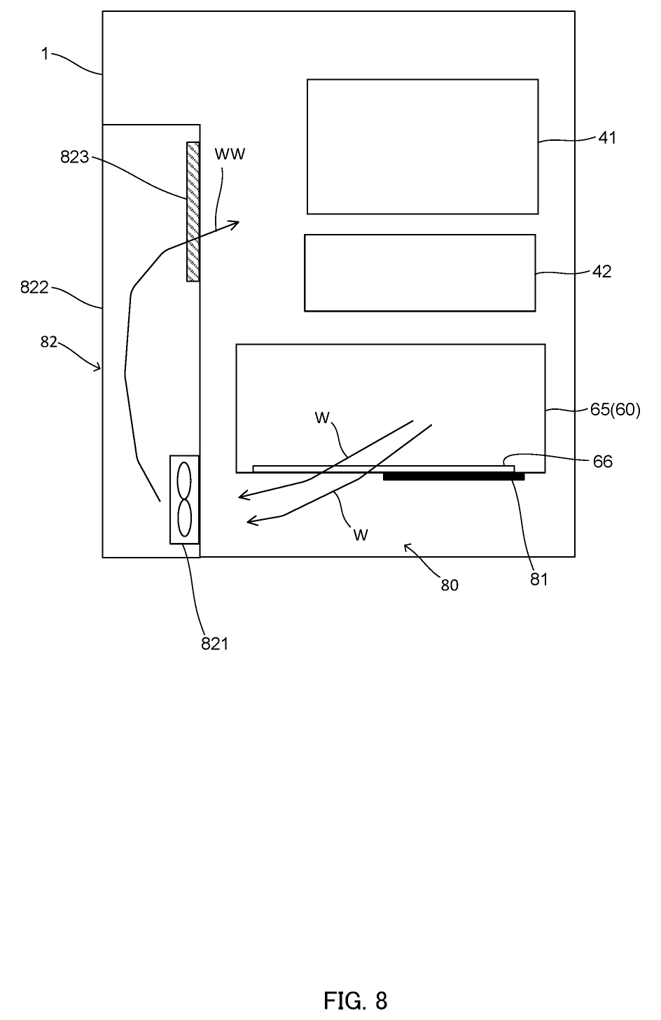

In addition, in the above embodiment, the collector 823 is disposed outside the image forming apparatus 1 in the box 822 at a position where the air in the box 822 is dischargeable, but the present invention is not limited thereto. For example, as illustrated in FIG. 8, the collector 823 may be disposed in the box 822 so as to be directed toward the inside of the image forming apparatus 1.

The collector 823 is disposed, for example, in the box 822, at a position corresponding to the image forming unit 41 of the image forming apparatus 1 so as to be capable of releasing the air in the box 822.

Thus, wind WW from which UFPs are collected by the collector 823 is easily blown to the vicinity of the charging apparatus 414 of the image forming unit 41.

In the vicinity of the charging apparatus 414, for example, UFPs may be floating due to the influence of wind from the fixer 60. When UFPs adhere to the charging electrode of the charging apparatus 414, an insulating film may be generated due to discharge of the charging electrode, and further charging may be performed at a near position, which may cause an image defect. For this reason, it is necessary to suppress adhesion of UFPs to the charging electrode of the charging apparatus 414.

Accordingly, wind generated at the fixer 60 can be used to collect UFPs and remove UFPs near the charging apparatus 414. As a result, UFPs floating in the vicinity of the charging apparatus 414 can be efficiently removed.

In addition, although the guide 80 includes the shielding member 81 in the embodiment described above, the present invention is not limited to this, and the guide 80 may include a wind path former, such as a duct, which guides wind to the discharger.

In addition, although the shielding member 81 is configured to have a sheet shape in the above-described embodiment, the present invention is not limited thereto, and the shielding member 81 may be configured to have a shape other than a sheet shape, for example, a sponge shape.

In addition, in the above-described embodiment, the wind blower 70 includes the first wind blower 71 and the second wind blower 72. However, the present invention is not limited thereto, and the wind blower 70 may include only one wind blower or may include three or more wind blowers.

In addition, any of the embodiment described above is only illustration of an exemplary embodiment for carrying out the present invention, and the technical scope of the present invention shall not be construed limitedly thereby. That is, the present invention can be carried out in various forms without departing from the gist or the main features thereof.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus that forms an image on a recording medium, the image forming apparatus comprising:
a fixer that includes a housing and fixes the image formed on the recording medium, the housing being a housing in which an opening is formed;
a wind blower that blows wind in the housing; and
a guide that guides the wind blowing out from the opening such that the wind is not diffused in the image forming apparatus.

2. The image forming apparatus according to claim 1, wherein
the guide includes a shielding member that at least partially shields the opening.

3. The image forming apparatus according to claim 2, wherein:
the guide further includes a discharger that is provided on a lateral side of the housing in the image forming apparatus and discharges the wind in the image forming apparatus, and
the shielding member is disposed so as to shield a portion including an end of the opening opposite to the discharger with respect to the housing and so as not to shield a portion including an end of the opening on a side of the discharger with respect to the housing.

4. The image forming apparatus according to claim 3, wherein
the opening is provided on a side surface of the housing on a downstream side in a conveyance direction of the recording medium.

5. The image forming apparatus according to claim 4, wherein:
the opening is provided at a connection portion between an opener and the housing, the opener being capable of opening the housing, and
the shielding member is constituted by a sheet-shaped member deformable as the opener opens.

6. The image forming apparatus according to claim 2, wherein:
the opening is provided on a side surface of the housing on an upstream side in a conveyance direction of the recording medium, and
the shielding member is disposed so as to shield the opening entirely.

7. The image forming apparatus according to claim 1, further comprising a driving unit that drives the image forming apparatus, wherein
the fixer
is disposed at a position adjacent to the driving unit,
further includes a cover that covers at least a portion of the housing, the portion including a portion of the opening, and
the cover includes a vent that opens on a side opposite to the driving unit with respect to the housing.

8. The image forming apparatus according to claim 3, wherein
the discharger includes a sucker, a box, and a collector, the sucker sucking air in the image forming apparatus, the box causing the air sucked by the sucker to be retained, the collector being provided in the box and collecting fine particles included in the air in the box.

9. The image forming apparatus according to claim 8, wherein
the collector is detachable from the box.

10. The image forming apparatus according to claim 8, wherein
the collector is disposed at a position where the air in the box is dischargeable to an outside of the image forming apparatus.

11. The image forming apparatus according to claim 8, wherein
the collector is disposed, in the box, at a position corresponding to an image forming unit inside the image forming apparatus, the position being a position where the collector is capable of releasing the air in the box.
